(19) United States
(12) Patent Application Publication
(10) Pub. No.: US 2008/0084990 A1
(43) Pub. Date: Apr. 10, 2008

(54) METHOD AND SYSTEM FOR CONTROLLING COMMUNICATION REPLIES

(75) Inventors: Michael T. Vincent, Lake Worth, FL (US); Daniel A. Baudino, Lake Worth, FL (US); Scott D. Berger, Coral Springs, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/535,715

(22) Filed: Sep. 27, 2006

(51) Int. Cl. H04M 1/00

(52) U.S. Cl. 379/354

(57) ABSTRACT

The invention concerns a method (200) and system (100) for controlling communication replies. The method can include the steps of selecting (210) one or more recipients of a call at an originating communication unit (110), placing (212) the call to the selected recipients and sending (214) along with the placed call a no reply indicator to the recipients of the call that will automatically block a reply call from the recipients. This block may prevent the recipients from having an opportunity to place the reply call. The method may also include the step of receiving (216) an acknowledgement from one or more of the recipients that indicates that the recipients received the placed call. As an example, the call can be a dispatch call, and the recipients can be members of a predetermined dispatch group.

### BACKGROUND OF THE INVENTION

1. Field of the Invention

The present invention concerns group communications in a communications network and more particularly, controlling such communications on the part of a call originator.

2. Description of the Related Art

One of the features of dispatch communications is the ability to generate a group of dispatch callers, each of whom may be simultaneously contacted by a single caller. In particular, this originating caller may select a group from a menu of his handset and then can press a push-to-talk (PTT) button to attempt to contact all the members of the group at the same time. The number of individuals in this group may be quite large. As such, the call originator may be bombarded with responses from a large number of the callees of the group. These responses may not be necessary, and the call originator may wish to avoid receiving all these return calls. Even so, the call originator may wish to ensure that all (or at least some of) the members of the group received the originating call.

### SUMMARY OF THE INVENTION

The present invention concerns a method and system for controlling communication replies. The method can include the steps of selecting one or more recipients of a call at an originating communication unit, placing the call to the selected recipients and sending along with the placed call a no reply indicator to the recipients of the call that can automatically block a reply call from the recipients. As such, the recipients may not be provided with an opportunity to place the reply call. As an example, the call can be a dispatch call, and the recipients can be members of a predetermined dispatch group.

The method can also include the step of receiving an acknowledgement from one or more of the recipients that can indicate that the recipients received the placed call or a negative acknowledgement from one or more of the recipients that can indicate that the recipients did not receive the placed call. The method can also include the step of displaying at the originating communication unit a list that can show the recipients from which acknowledgements or negative acknowledgements were received. As an example, the acknowledgement and the negative acknowledgement can be generated from the recipients activating a mechanism on communication units of the recipients.

In one arrangement, the mechanism can be a PTT button, and the acknowledgement can be generated by activating the PTT button with a single press. Conversely, the negative acknowledgement can be generated by activating the PTT button with at least two consecutive presses. In addition, the negative acknowledgement can be generated automatically by the communication units of the recipients if no response is received from the recipients after a predetermined amount of time.

The present invention also concerns a communication unit. The communication unit can include a user interface that can permit a user to select one or more recipients of a call and a no reply indicator for the call, a transceiver that can transmit the call to the selected recipients and a processor that can be coupled to the user interface and the transceiver. The processor can be programmed to cause the transceiver to transmit the no reply indicator along with the transmitted call. Further, the no reply indicator can automatically block a reply call from the recipients such that the recipients may not be provided with an opportunity to place the reply call. The system can also include suitable software and circuitry to carry out any of the processes or steps described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for controlling communication replies in accordance with an embodiment of the inventive arrangements; and

FIG. 2 illustrates a method for controlling communication replies in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “processor” can include any component or group of components, including any relevant hardware and/or software, that can carry out the functions described in relation to the inventive arrangements herein.

The term “communication unit” can be defined as any electronic device capable of receiving and/or transmitting wireless and/or hard-wired communication signals. The term “transceiver” can be any component or group of components that are capable of receiving and transmitting communications signals. The term “recipient” can refer to any entity, including a machine, that is designated to receive a communication. The term “originating” or “originator” can refer to the property of initiating, commencing or starting an act or process.

The invention concerns a method and system for controlling communication replies. The method can include the steps of selecting one or more recipients of a call at an originating communication unit, placing the call to the selected recipients and sending along with the placed call a no reply indicator to the recipients of the call that can automatically block a reply call from the recipients. This block may prevent the recipients from having an opportunity to place the reply call. The method may also include the step of receiving an acknowledgement from one or more of the recipients that indicates that the recipients received the placed call. As an example, the call can be a dispatch call, and the recipients can be members of a predetermined dispatch group.

Such a process can enable the person originating the call from receiving a large number of needless replies to a simple origination communication. This feature can also free up network resources and can limit expenses to the users of the communication units, which otherwise may have been charged for the needless replies.

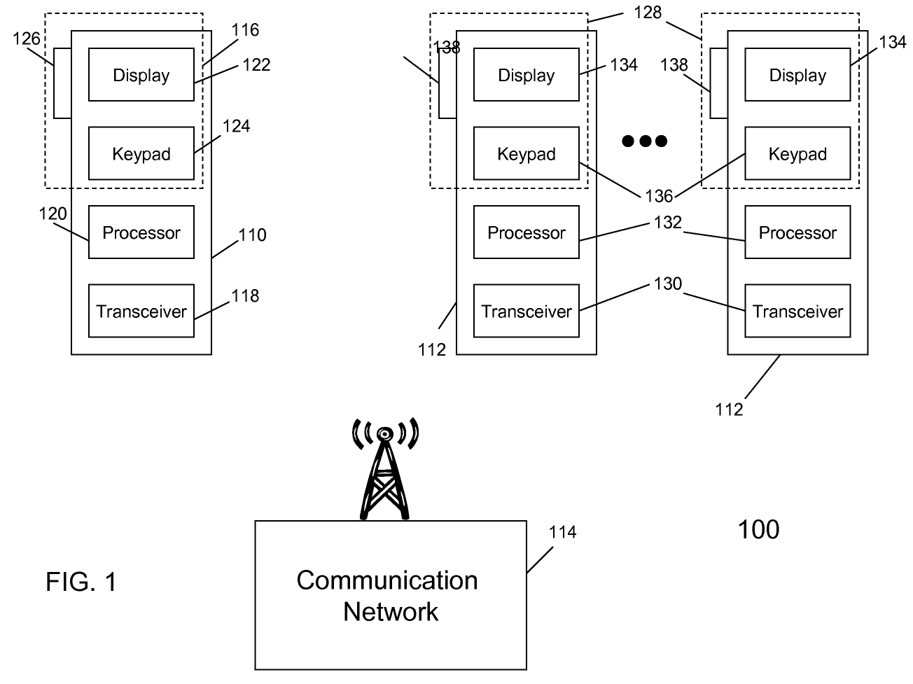

Referring to FIG. 1, a system 100 for controlling communication replies is shown. In one arrangement, the system 100 can include an originating communication unit 110 and one or more recipient communication units 112. Both the originating communication unit 110 and the recipient communication units 112 can communicate with a communication network 114, although it is understood that the units 110 and 112 may communicate with one another without the assistance of the network 114. Moreover, while the units 110 and 112 here are shown as wireless devices, it must be noted that the invention is not so limited, as it also applies to hard-wired devices.

The originating unit 110 may include a user interface 116, a transceiver 118 and a processor 120 coupled to both the user interface 116 and the transceiver 118. The user interface 116 can include a display 122, a keypad 124 and an activation mechanism 126, which can be used to initiate a call from the originating unit 110. For example and without limitation, the activation mechanism 126 may be a PTT button for initiating dispatch calls.

The recipient unit 112 may also include a user interface 128, a transceiver 130 and a processor 132 coupled to both the user interface 128 and the transceiver 130. Similar to the originating unit 110, the user interface 128 of the recipient unit 112 may include a display 134, a keypad 136 and an activation mechanism 138, which, as an example, may be a PTT button for responding to dispatch calls.

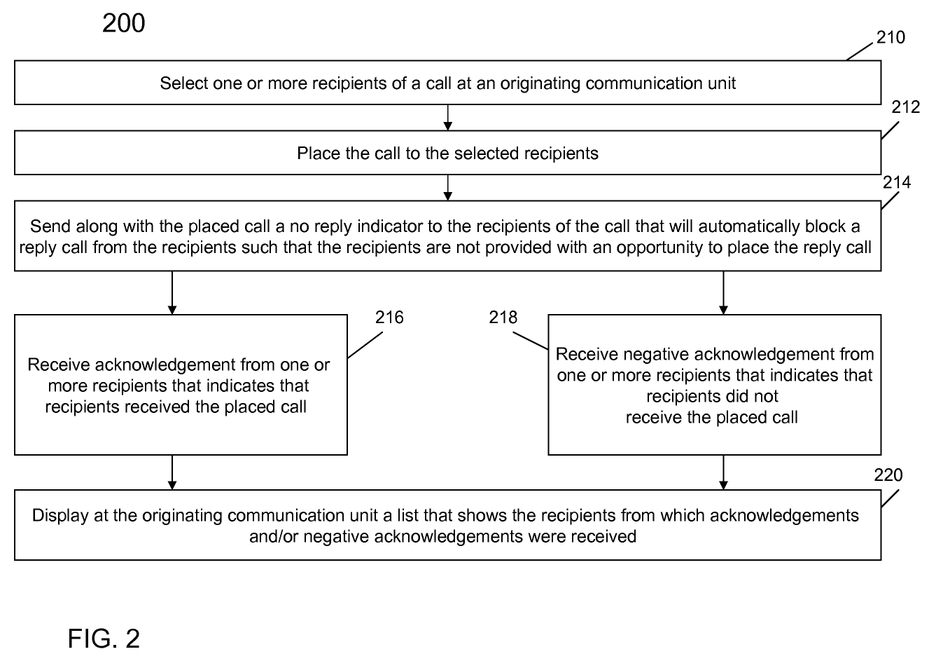

Referring to FIG. 2, a method 200 for controlling communication replies is shown. When describing the method 200, reference will be primarily made to FIG. 1, although it is understood that the method 200 can be practiced in any other suitable system or device. Moreover, the steps of the method 200 are not limited to the particular order in which they are presented in FIG. 2. The inventive method can also have a greater number of steps or a fewer number of steps than those shown in FIG. 2.

At step 210, one or more recipients of a call can be selected at an originating communication unit. At step 212, the call can be placed to the selected recipients. A no reply indicator can be sent along with the placed call to the recipients of the call that will automatically block a reply call from the recipients such that the recipients are not provided with an opportunity to place the reply call, as shown at step 214.

For example, referring to FIG. 1, a user of the originating communication unit 110 can select recipients of a call. A call can be defined as any communication intended for two or more parties that can include any suitable type of information, including voice, text, images, etc. The recipients can be selected from any suitable contact list in the originating unit 110, such as through the display 122 and keypad 124. In one particular example, the call can be a group call in which a plurality of recipients are designated for receipt of the call. This group may be a predetermined band of contact numbers assembled at a previous time or can be a selection of contact numbers put together at the time of the call. This group call may be, for example, a dispatch group call, although the invention is in no way limited to such a group call.

The user of the originating unit 110 can then place the call to the selected recipients. Placing a call can be defined as any steps or processes taken to initiate a communication or at least an attempted communication with one or more recipients. For example, the user of the originating unit 110 may activate the activation mechanism 126 once the recipients have been selected. In one particular example and as described earlier, the activation mechanism 126 may be a PTT button, and the user of the unit 110 may press the PTT button to place the call.

In one embodiment, the user of the originating unit 110 may wish to avoid receiving replies from one or more of the recipients. As such, the user of the unit 110 may select a no reply indicator in the process of arranging the call. This indicator can be selected from, for example, a menu on the display 122, and in response, the processor 120 can instruct the transceiver 118 to transmit the no reply indicator along with the placed call. This no reply indicator can be a flag or any other suitable parameter in the placed call and can be transmitted to the recipient communication units 112 over any suitable channel. If the call is a dispatch call, for example, the no reply indicator can be a flag in a data packet placed in a traffic channel or any suitable control channel. In fact, the no reply indicator can be any suitable type of information transmitted from an originating communication unit that is capable of informing recipient communication units that no reply to the placed call is necessary or wanted.

Once received by the transceivers 130 of the recipient communication units 112, the processors 132 can process the no reply indicator and can configure the units 112 such that the users of these units 112 may not be afforded with an opportunity to place a reply call. A reply call can be defined as a call in which the recipients of the placed call respond with an active communication back to the originator, such as through speaking into his/her communication unit or entering text or images into the unit. For example, the processor 132 may instruct the transceiver 130 to avoid transmitting voice and/or data back to the originating unit 110. Such a process can prevent the originator of the placed call from receiving numerous unwanted responses to the placed call.

Although the example described above focuses on a group dispatch call, it is understood that the invention is not so limited. This idea can apply to all types of communications over any suitable communication network or protocol, including Voice over Internet Protocol (VoIP) or Push-over-Cellular (PoC). While the invention can certainly apply to voice calls, it is not limited as such, as this process is suitable for non-voice communications, including text messages or e-mail. Moreover, the number of recipients is not necessarily limited to a plurality of recipients, as a no reply indicator can be sent to a single recipient, if so desired.

Referring back to FIG. 2, at step 216, one or more acknowledgements can be received from one or more of the recipients that indicates that the recipients received the placed call. Also, at step 218, one or more negative acknowledgements can be received from one or more recipients that indicates that the recipients did not receive the placed call. A list that shows the recipients from which acknowledgements and/or negative acknowledgements were received can be displayed at the originating communication unit, as shown at step 220.

Referring back to FIG. 1, the recipients of the placed call can send an acknowledgment from their communication units 112. For example, these users can generate the acknowledgement by activating the activation mechanism 138 on their units 112. In particular, if the activation mechanism 138 is a PTT button, the user can acknowledge receipt of the placed call by pressing the PTT button a single time, for example.

Conversely, if the recipient, for any reason, did not receive the placed call or possibly misunderstood the call, the recipient can generate a negative acknowledgement through the activation mechanism 138. For example, if the activation mechanism 138 is a PTT button, the recipient could press the PTT button at least twice (consecutively) in response to not receiving the placed call. While not afforded an opportunity to place a reply call, the recipients can provide an indication as to whether they received the originating call. In one arrangement, if the recipient is unavailable and has yet to respond, following a predetermined amount of time, the processor 132 of the recipient communication unit 112 can automatically generate the negative acknowledgement. Moreover, the recipients of the placed call can take any other suitable action to generate the acknowledgement or negative acknowledgement, as the invention is not limited to the use of a PTT button to do so.

The acknowledgements and/or negative acknowledgements can be received at the originating communication unit 110. In response, the processor 120 can process this information and can cause it to be shown on the display 122. This way, the originator can quickly determine which members of the group call received the originating placed call without having to be interrupted with a plurality of reply calls. If there are negative acknowledgements, the user of the originating unit 110 can attempt to place another call with those recipients.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for controlling communication replies, comprising:
selecting one or more recipients of a call at an originating communication unit;
placing the call to the selected recipients; and
sending along with the placed call a no reply indicator to the recipients of the call that will automatically block a reply call from the recipients such that the recipients are not provided with an opportunity to place the reply call.

2. The method according to claim 1, further comprising receiving an acknowledgement from one or more of the recipients that indicates that the recipients received the placed call.

3. The method according to claim 2, further comprising displaying at the originating communication unit a list that shows the recipients from which acknowledgements were received.

4. The method according to claim 2, wherein the acknowledgement is generated from the recipients activating a mechanism on communication units of the recipients.

5. The method according to claim 4, wherein the mechanism is a push-to-talk (PTT) button and the PTT button is activated by a single press.

6. The method according to claim 1, further comprising receiving a negative acknowledgement from one or more of the recipients that indicates that the recipients did not receive the placed call.

7. The method according to claim 6, further comprising displaying at the originating communication unit a list that shows the recipients from which negative acknowledgements were received.

8. The method according to claim 6, wherein the negative acknowledgement is generated from the recipients activating a mechanism on communication units of the recipients or automatically by the communication units of the recipients if no response is received from the recipients after a predetermined amount of time.

9. The method according to claim 8, wherein the mechanism is a PTT button and the PTT button is activated by at least two consecutive presses.

10. The method according to claim 1, wherein the call is a dispatch call and the recipients are members of a predetermined dispatch group.

11. A communication unit, comprising:
a user interface that permits a user to select one or more recipients of a call and a no reply indicator for the call;
a transceiver that transmits the call to the selected recipients; and
a processor that is coupled to the user interface and the transceiver, wherein the processor is programmed to cause the transceiver to transmit the no reply indicator along with the transmitted call and wherein the no reply indicator automatically blocks a reply call from the recipients such that the recipients are not provided with an opportunity to place the reply call.

12. The communication unit according to claim 11, wherein the transceiver receives an acknowledgement from one or more of the recipients that indicates that the recipients received the placed call.

13. The communication unit according to claim 12, further comprising a display that is part of the user interface and that displays a list that shows the recipients from which acknowledgements were received.

14. The communication unit according to claim 12, wherein the acknowledgement is generated from the recipients activating a mechanism on communication units of the recipients.

15. The communication unit according to claim 14, wherein the mechanism is a push-to-talk (PTT) button and the PTT button is activated by a single press.

16. The communication unit according to claim 11, wherein the transceiver receives a negative acknowledgement from one or more of the recipients that indicates that the recipients did not receive the transmitted call.

17. The communication unit according to claim 16, further comprising a display that is part of the user interface and that shows a list of the recipients from which negative acknowledgements were received.

18. The communication unit according to claim 16, wherein the negative acknowledgement is generated from the recipients activating a mechanism on communication units of the recipients or automatically by the communication units of the recipients if no response is received from the recipients after a predetermined amount of time.

19. The communication unit according to claim 18, wherein the mechanism is a PTT button and the PTT button is activated by at least two consecutive presses.

20. The communication unit according to claim 11, wherein the call is a dispatch call and the recipients are members of a predetermined dispatch group.

21. A recipient communication unit, comprising:
a transceiver that receives an originating call from an originating communication unit, wherein the originating call includes a no reply indicator; and
a processor that is coupled to the transceiver, wherein the processor is programmed to automatically block the recipient communication unit from attempting a reply call from a recipient of the originating call such that the recipients are not provided with an opportunity to place the reply call.
